(19) United States
(12) Patent Application Publication
(10) Pub. No.: US 2026/0001466 A1
(43) Pub. Date: Jan. 1, 2026

(54) ARMREST

(71) Applicant: TACHI-S CO., LTD., Tokyo (JP)

(72) Inventors: Hiroshi ARIMA, Tokyo (JP); Tomohisa KUNIE, Tokyo (JP); Tatsunori OKAZAKI, Tokyo (JP); Jyunichi UTSUMI, Tokyo (JP)

(73) Assignee: TACHI-S CO., LTD., Tokyo (JP)

(21) Appl. No.: 19/246,834

(22) Filed: Jun. 24, 2025

(30) Foreign Application Priority Data
Jun. 27, 2024 (JP) 2024-104396

(51) Int. Cl. B60N 2/75; B60N 3/10

(52) U.S. Cl. CPC B60N 2/793; B60N 2/757; B60N 3/102

(57) ABSTRACT

To provide an armrest that enables suppression of deterioration of the mountability of an accommodation member to a frame and that can make it less likely for the accommodation member to be detached from the frame. A claw of a second engaging portion and a second to-be-engaged portion are opposed to each other in a first direction (the direction of arrows U-D) over an overlap length in a state where an extending portion of the second engaging portion has been brought into contact with an outer peripheral surface of a body portion by elastically deforming the extending portion about a base side from a state where the claw is hooked on the second to-be-engaged portion.

### BACKGROUND OF THE INVENTION

### 1. Field of the Invention

The present invention relates to an armrest, and in particular, relates to an armrest that enables suppression of deterioration of the mountability of an accommodation member to a frame and that can make it less likely for the accommodation member to be detached from the frame.

### 2. Description of the Related Art

Armrests have been known. Each of the armrests is formed by supporting a pad formed of foam on a frame, and the pad is provided with a recess accommodating an accommodation member such as a cup holder. In Japanese Patent Application Laid-Open (kokai) No. 2023-010766, an armrest has an upper surface provided with a recess accommodating an accommodation member, and the accommodation member is enclosed by wires of a frame. The accommodation member has a body portion having: a front side from which a first engaging portion having a U shape as seen in a leftward-rightward direction protrudes; and a back side on which a second engaging portion having the shape of a hook as seen in the leftward-rightward direction is provided. The second engaging portion includes: a base connected to the body portion; an extending portion extending downward from the base and located away from the body portion backward; and a claw protruding backward from the lower end of the extending portion.

In order to mount the accommodation member to the frame, the first engaging portion having a U shape is fitted to a wire (first to-be-engaged portion), and then the accommodation member is rotated downward about the first engaging portion, and the lower surface of the claw is pressed against a wire (second to-be-engaged portion). Further downward rotation causes the claw to slip on the wire. Consequently, the extending portion is elastically deformed to the accommodation member side. Thus, the claw passes over the wire and is hooked on the wire, whereby mounting is completed.

### SUMMARY OF THE INVENTION

However, the above conventional technology has the following problem. That is, when the rigidity of the extending portion of the second engaging portion is low, although the extending portion can be elastically deformed with a small force at the time of mounting the accommodation member to the frame, an upward pull of the accommodation member easily leads to elastic deformation of the extending portion. Therefore, the claw is easily detached from the wire, i.e., the accommodation member is easily detached from the frame. Meanwhile, when the rigidity of the extending portion is high, although the claw can be made less likely to be detached from the wire, a large force is required for mounting the accommodation member. Therefore, the mountability thereof deteriorates.

The present invention has been made to solve the above problem, and an object of the present invention is to provide an armrest that enables suppression of deterioration of the mountability of an accommodation member to a frame and that can make it less likely for the accommodation member to be detached from the frame.

In order to achieve the object, an armrest according to the present invention includes: a frame; a pad supported on the frame and formed of foam; and an accommodation member configured to be accommodated in a recess obtained through recession from an outer surface of the pad to one side in a first direction. The frame includes: a first to-be-engaged portion located on one side, in a second direction perpendicular to the first direction, relative to the accommodation member; and a second to-be-engaged portion located on another side, in the second direction, relative to the accommodation member. The accommodation member includes: a body portion having an outer peripheral surface configured to be opposed to an inner peripheral wall surface defining the recess; a first engaging portion provided to the outer peripheral surface and configured to be attached to the first to-be-engaged portion such that the accommodation member is rotatable in the first direction about the first to-be-engaged portion; and a second engaging portion elastically deformable and configured to be hooked on the second to-be-engaged portion. The second engaging portion includes: a base connected to the body portion; an extending portion extending from the base to the one side in the first direction and disposed away from the outer peripheral surface in the second direction; and a claw protruding from the extending portion to a side opposite to the outer peripheral surface and having, on another side in the first direction, a surface on which the second to-be-engaged portion is to be hooked. The claw and the second to-be-engaged portion are opposed to each other in the first direction over an overlap length in a state where the extending portion has been brought into contact with the outer peripheral surface by elastically deforming the extending portion about the base side from a state where the claw is hooked on the second to-be-engaged portion.

In the armrest according to the first aspect, the claw and the second to-be-engaged portion are opposed to each other in the first direction over the overlap length in the state where the extending portion has been brought into contact with the outer peripheral surface of the body portion by elastically deforming the extending portion about the base side from the state where the claw is hooked on the second to-be-engaged portion. Consequently, the overlap length can make it less likely for the claw to be detached from the second to-be-engaged portion, almost irrespective of the rigidity of the extending portion (even when the extending portion undergoes significant elastic deformation). In addition, the rigidity of the extending portion does not have to be increased in order to make such detachment less likely in this manner, whereby deterioration of the mountability of the second engaging portion to the second to-be-engaged portion due to increase in the rigidity can be suppressed. By the above features, deterioration of the mountability of the accommodation member to the frame can be suppressed, and moreover, the accommodation member can be made less likely to be detached from the frame.

An armrest according to a second aspect exhibits the following advantageous effects in addition to the advantageous effects exhibited by the armrest according to the first aspect. The claw has, on the extending portion side, a root having a thickness of 5 mm or larger and 10 mm or smaller as seen in a third direction perpendicular to the first direction and the second direction. The extending portion has, on the base side, a root having a second moment of area of 100 mm⁴ or larger in a cross section perpendicular to the first direction. As a result of these features, the balance between the rigidities of the claw and the extending portion can be made favorable. Therefore, the accommodation member can be made further less likely to be detached from the frame, and moreover, the mountability of the accommodation member to the frame can be further improved.

An armrest according to a third aspect exhibits the following advantageous effect in addition to the advantageous effects exhibited by the armrest according to the first aspect. The second to-be-engaged portion is formed in a shape of a round rod extending in a third direction perpendicular to the first direction and the second direction. The overlap length for the claw and the second to-be-engaged portion is not smaller than half a diameter of the second to-be-engaged portion. Consequently, the overlap length can be ensured, whereby the accommodation member can be made further less likely to be detached from the frame.

An armrest according to a fourth aspect exhibits the following advantageous effects in addition to the advantageous effects exhibited by the armrest according to the first aspect. A length in the first direction of the extending portion is larger than a length in the first direction of the base. Consequently, the extending portion can be easily elastically deformed so as to be warped over the entire length thereof in the first direction at the time of mounting, whereby the mountability of the accommodation member to the frame can be improved. Meanwhile, since the base is small, stresses applied upon elastic deformation of the extending portion easily concentrate on a connection portion between the base and the body portion, whereby the durability of the connection portion might decrease.

Considering this, the body portion includes a flange protruding outward from an upper end of the outer peripheral surface. The base of the second engaging portion is connected to the outer peripheral surface and the flange of the body portion. Consequently, as compared to a case where the base is connected to only one of the outer peripheral surface or the flange, stresses applied to the connection portion upon elastic deformation of the extending portion are easily dispersed, whereby the durability of the connection portion can be ensured.

### BRIEF DESCRIPTION OF THE DRAWINGS

FIG. 1 is a perspective view of a seat provided with an armrest according to an embodiment.

FIG. 2 is a cross-sectional view, of the armrest, taken at a line II-II in FIG. 1.

FIG. 3 is a bottom view of an accommodation member.

FIG. 4 is a schematic diagram showing a method for mounting the accommodation member to a frame.

### DESCRIPTION OF THE PREFERRED EMBODIMENTS

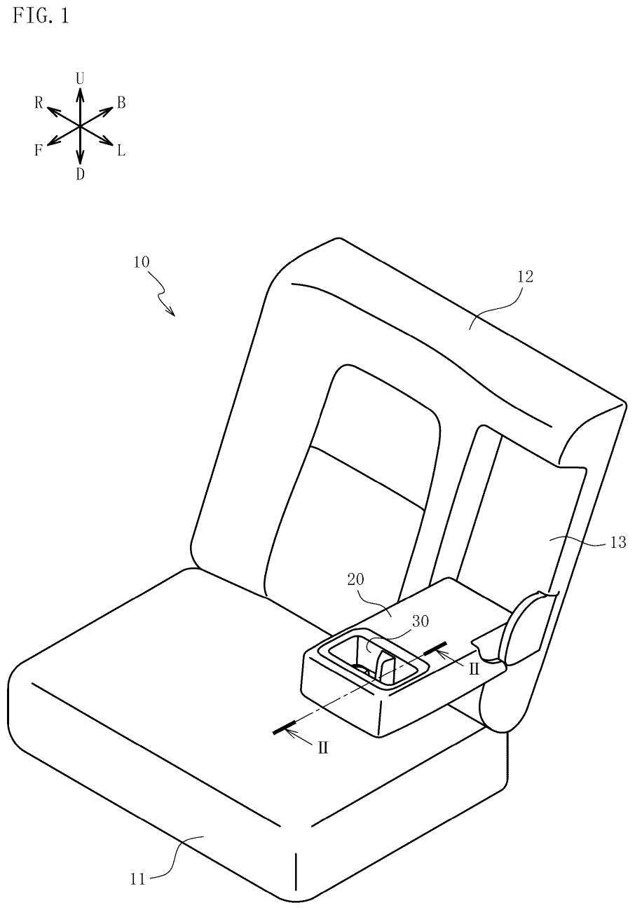

Hereinafter, a preferred embodiment of the present invention will be described with reference to the accompanying drawings. FIG. 1 is a perspective view of a seat 10 provided with an armrest 20 according to the embodiment. In each of the drawings, the direction of an arrow D (one side in a first direction), the direction of an arrow U (another side in the first direction), the direction of an arrow L, the direction of an arrow R, the direction of an arrow F (one side in a second direction), and the direction of an arrow B (another side in the second direction) respectively indicate a downward direction, an upward direction, a leftward direction, a rightward direction, a frontward direction, and a backward direction of the seat 10. These directions are identical to respective directions as seen from a person seated on the seat 10. Also, the upward-downward direction (first direction), the leftward-rightward direction (third direction), and the frontward-backward direction (second direction) are perpendicular to one another.

The seat 10 is a seat mounted in a car (e.g., an automobile). The seat 10 mainly includes: a seat cushion 11 forming a seating surface; a seat back 12 rotatably supported on the seat cushion 11 and forming a backrest; and the armrest 20 which is capable of forming a rest for an arm and which has a proximal end part rotatably supported on the seat back 12.

The seat cushion 11 is formed by: supporting, on a cushion frame (not shown) formed of a metal or a synthetic resin, a cushion pad (not shown) formed of foam such as soft polyurethane foam; and covering the cushion pad by a skin material (not shown). The seat cushion 11 in the present embodiment forms seating surfaces, for two persons, of a back seat of the car.

Likewise, the seat back 12 is formed by: supporting, on a back frame (not shown) formed of a metal or a synthetic resin, a back pad (not shown) formed of foam such as soft polyurethane foam; and covering the back pad by a skin material (not shown).

The seat back 12 in the present embodiment can form backrests, for two persons, of the back seat of the car. Out of the backrests for two persons, the backrest on the left side is partially formed by the armrest 20 in an accommodated state where the armrest 20 is raised upward from a state in FIG. 1. The seat back 12 has a front surface in which an accommodation recess 13 for accommodating the armrest 20 is formed. The accommodation recess 13 is opened also in a left side surface of the seat back 12.

The state shown in FIG. 1 where the armrest 20 is tilted so as to be substantially parallel to the seat cushion 11 is an in-use state of the armrest 20. On the armrest 20 in the in-use state, an arm of a person seated on the right side on the seat 10 and an arm of a person seated on a seat separately provided on the left side relative to the seat 10 can be placed.

Hereinafter, the armrest 20 will be basically described by using directions in the in-use state. The armrest 20 has, on the front side, a distal end part having an upper surface in which an accommodation member 30 is embedded. The accommodation member 30 in the present embodiment is a cup holder receiving and holding a cup for drink or the like.

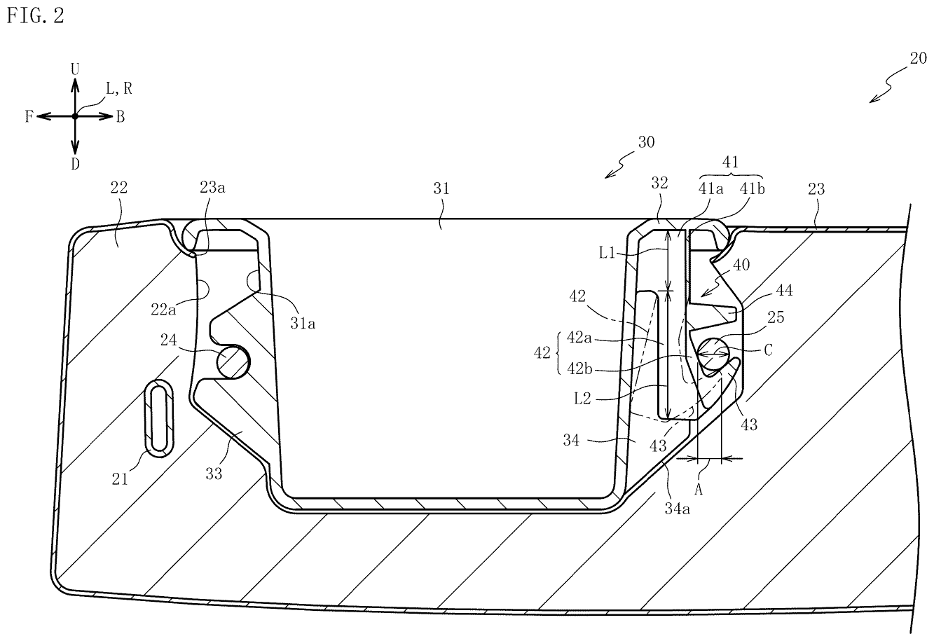

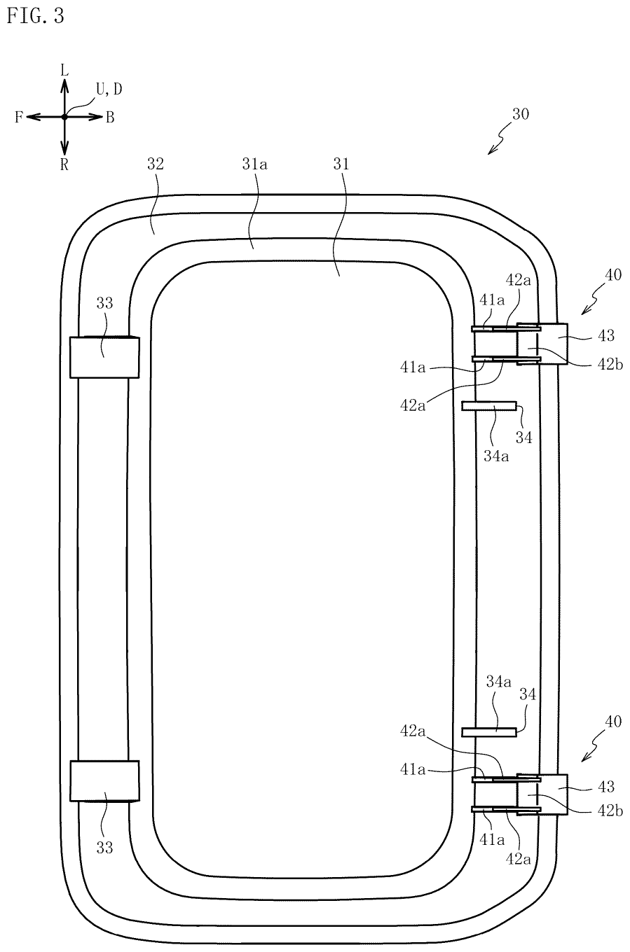

FIG. 2 is a cross-sectional view, of the armrest 20, taken at a line II-II in FIG. 1. FIG. 3 is a bottom view of the accommodation member 30. The armrest 20 is formed by: supporting, on a frame 21 formed of a metal or a synthetic resin, a pad 22 formed of foam such as soft polyurethane foam; and covering the pad 22 by a skin material 23.

The skin material 23 has an upper surface having an opening 23a into which the accommodation member 30 is inserted. Furthermore, the pad 22 has a recess 22a obtained through downward recession from an upper surface (outer surface) of the pad 22. The accommodation member 30 is accommodated in the recess 22a.

The frame 21 is formed by joining a wire to a frame body through welding or the like and is embedded in the pad 22. The wire is a member that has the shape of a round rod and that is formed of a metal, the member enclosing the accommodation member 30 inside the recess 22a. The wire includes: a first to-be-engaged portion 24 located on the front side relative to the accommodation member 30; and a second to-be-engaged portion 25 located on the back side relative to the accommodation member 30.

The first to-be-engaged portion 24 and the second to-be-engaged portion 25 extend along the leftward-rightward direction so as to be parallel to each other, and the relative position therebetween is fixed. Although the first to-be-engaged portion 24 and the second to-be-engaged portion 25 in FIG. 2 are exposed in the recess 22a, these to-be-engaged portions may be embedded in the pad 22 without being exposed in the recess 22a as long as these to-be-engaged portions are located near inner peripheral wall surfaces defining the recess 22a.

The accommodation member 30 includes: a body portion 31 which is formed in a substantially quadrangular tubular shape and which has an opened upper end and a closed lower end; a first engaging portion 33 to be attached to the first to-be-engaged portion 24; a restriction portion 34 which makes it less likely for the first engaging portion 33 to be detached from the first to-be-engaged portion 24; and a second engaging portion 40 which is elastically deformable and which is to be hooked on the second to-be-engaged portion 25. These portions are integrally formed by using a synthetic resin.

The body portion 31 includes: outer peripheral surfaces 31a to be opposed to the respective inner peripheral wall surfaces defining the recess 22a and to face the respective front, back, left, and right sides; and a flange 32 protruding outward from the entireties of the upper ends of the outer peripheral surfaces 31a (body portion 31). The flange 32 is a portion to be superposed on the upper surface of the skin material 23 so as to close the opening 23a.

The first engaging portion 33 is a portion protruding from the outer peripheral surface 31a, on the front side, of the body portion 31, and two said first engaging portions 33 are provided away from each other in the leftward-rightward direction. Each of the first engaging portions 33 is formed in a U shape opened to the front side as seen in the leftward-rightward direction. Attachment is performed such that the first to-be-engaged portion 24 having the shape of a round rod is inserted into the first engaging portion 33 having the U shape. Consequently, the accommodation member 30 is rotatable in the upward-downward direction about the first to-be-engaged portion 24 in a state where the second engaging portion 40 is not hooked on the second to-be-engaged portion 25.

The restriction portion 34 is a portion that is raised from and substantially perpendicular to the outer peripheral surface 31a, on the back side, of the body portion 31, and two said restriction portions 34 are provided away from each other in the leftward-rightward direction. Each of the restriction portions 34 is formed so as to extend downward from the flange 32 and is connected to the outer peripheral surface 31a over the entire length in the upward-downward direction. The restriction portion 34 has a lower end edge 34a which is tilted such that a part thereof on a further back side is located on a further upper side.

When the second engaging portion 40 is elastically deformed so as to approach the corresponding outer peripheral surface 31a of the body portion 31, and the accommodation member 30 is moved backward relative to the first to-be-engaged portion 24 and the second to-be-engaged portion 25, the first engaging portion 33 might be detached from the first to-be-engaged portion 24. However, before the first engaging portion 33 is detached, the back end edge of the restriction portion 34 comes into contact with the second to-be-engaged portion 25, whereby the relative backward movement of the accommodation member 30 is restricted. In this manner, the restriction portion 34 can inhibit the first engaging portion 33 from being detached from the first to-be-engaged portion 24.

The second engaging portion 40 is a portion provided on the back side of the body portion 31, and two said second engaging portions 40 are provided away from each other in the leftward-rightward direction, with the two restriction portions 34 being sandwiched therebetween. Each of the second engaging portions 40 includes: a base 41 connected to the outer peripheral surface 31a and the flange 32 of the body portion 31; an extending portion 42 extending downward from the base 41; a claw 43 protruding from the lower end of the extending portion 42 to the back side which is a side opposite to the outer peripheral surface 31a; and a protrusion 44 located above the claw 43 and protruding backward from the extending portion 42.

The base 41 includes: a pair of left and right side surface sheets 41a which are raised from and substantially perpendicular to the outer peripheral surface 31a and the lower surface of the flange 32; and a connection sheet 41b connecting the back ends of the respective side surface sheets 41a to each other. By these sheets, the base 41 is formed such that a cross section thereof perpendicular to the upward-downward direction has a U shape. Each of the side surface sheets 41a is a flat sheet perpendicular to the leftward-rightward direction. The connection sheet 41b is a flat sheet perpendicular to the frontward-backward direction.

The extending portion 42 is, over the entire length thereof in the upward-downward direction, located away from the outer peripheral surface 31a backward and has an upper end connected to the back side of the lower end of the base 41. The extending portion 42 includes: extension side surface sheets 42a obtained by extending the side surface sheets 41a of the base 41 downward; and an extension connection sheet 42b obtained by extending the connection sheet 41b of the base 41 downward. By these sheets, the extending portion 42 is formed such that a cross section thereof perpendicular to the upward-downward direction has a U shape. The extension connection sheet 42b has: an upper half formed in the shape of a flat sheet perpendicular to the frontward-backward direction; and a lower half formed in the shape of a flat sheet tilted such that a part thereof on a further lower side is located on a further back side.

The claw 43 has a root connected to the lower end of the extension connection sheet 42b and is tilted from the root such that a part, of the claw 43, closer to the tip thereof on the back side is located on a further upper side. The claw 43 has a lower surface that is curved in a convex shape as seen in the leftward-rightward direction. The claw 43 has an upper surface that is curved in a concave shape as seen in the leftward-rightward direction. The claw 43 has a thickness that is a dimension from the lower surface to the upper surface, and this thickness decreases from the root toward the tip of the claw 43. In the present embodiment, the thickness of the claw 43 is a dimension in a direction parallel to the back surface, on the lower side, of the extension connection sheet 42b.

The claw 43 is hooked on the second to-be-engaged portion 25 such that the second to-be-engaged portion 25 is in contact with each of the upper surface of the claw 43 and the back surface of the extension connection sheet 42b of the extending portion 42. Consequently, upward rotation of the accommodation member 30 about the first to-be-engaged portion 24 is restricted. Furthermore, the flange 32 is pressed against the upper surface of the pad 22 with the skin material 23 therebetween in a state where the claw 43 is hooked on the second to-be-engaged portion 25, whereby downward rotation of the accommodation member 30 is also restricted by an elastic reaction force of the pad 22. As a result of these features, the accommodation member 30 is mounted to the frame 21.

The protrusion 44 is a portion located above the second to-be-engaged portion 25 on which the claw 43 has been hooked. When, for example, the accommodation member 30 is forcefully pressed so as to be rotated downward, the protrusion 44 comes into contact with the second to-be-engaged portion 25, whereby further downward rotation can be restricted. As a result, the accommodation member 30 can be inhibited from deeply entering the recess 22a.

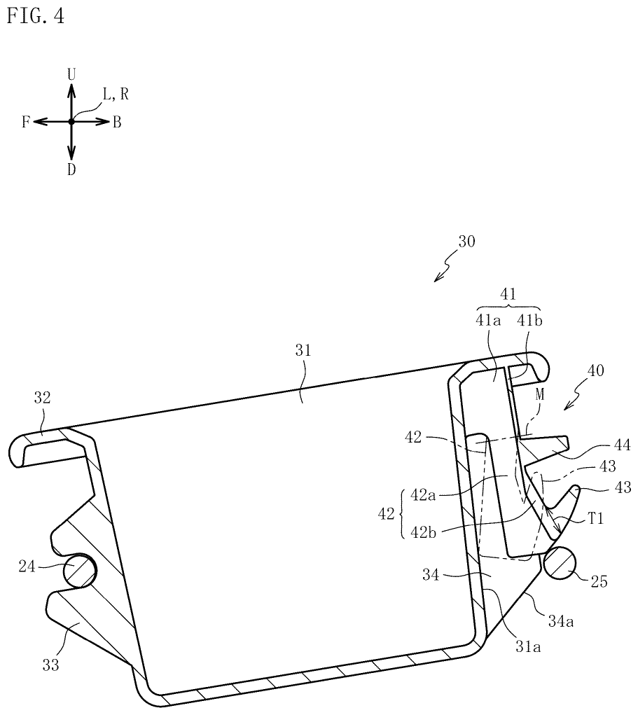

Next, a method for mounting the accommodation member 30 to the first to-be-engaged portion 24 and the second to-be-engaged portion 25 (frame 21) will be described with reference to FIG. 4. FIG. 4 is a schematic diagram showing the mounting method and shows a cross section similar to that in FIG. 2.

First, each of the first engaging portions 33 is fitted and attached to the first to-be-engaged portion 24 in a state where the accommodation member 30 is tilted such that the front side thereof is located on the lower side. Then, the back side of the accommodation member 30 is rotated downward about the first to-be-engaged portion 24 until the lower end of each of the second engaging portions 40 comes into contact with the second to-be-engaged portion 25.

When an attempt is made to move the accommodation member 30 backward relative to the first to-be-engaged portion 24 before this contact, the lower end edge 34a of each of the restriction portions 34 comes into contact with the second to-be-engaged portion 25, whereby the relative movement can be restricted. Consequently, the first engaging portion 33 can be inhibited from being detached from the first to-be-engaged portion 24 owing to the relative movement, and the second to-be-engaged portion 25 can be prevented from being fitted between the extending portion 42 and the outer peripheral surface 31a of the body portion 31 owing to the relative movement. Furthermore, since the lower end edge 34a of the restriction portion 34 is tilted such that a part thereof on a further back side is located on a further upper side, the second to-be-engaged portion 25 can be easily guided along the lower end edge 34a to the lower end of the second engaging portion 40.

After the lower end of the extending portion 42 of the second engaging portion 40 is brought into contact with the second to-be-engaged portion 25, the extending portion 42 is pressed against the second to-be-engaged portion 25, and the back side of the accommodation member 30 is further rotated downward. At this time, in a state where the first to-be-engaged portion 24 is inserted deep into the first engaging portion 33, the lower end of the extending portion 42 in contact with the second to-be-engaged portion 25 is tilted such that a part thereof on a further back side is located on a further upper side. This tilt continues to the tip of the claw 43. Consequently, the further downward rotation causes the second to-be-engaged portion 25 to slip along the above tilt so as to be guided to the tip of the claw 43 while causing elastic deformation of the second engaging portion 40 toward the outer peripheral surface 31a of the body portion 31. As a result, the claw 43 passes over, and is hooked on, the second to-be-engaged portion 25, whereby mounting of the accommodation member 30 to the frame 21 is completed.

As indicated by an alternate long and two short dashes line in FIG. 4, the elastic deformation of the second engaging portion 40 at the time of the mounting mainly involves elastic deformation of the extending portion 42 toward the outer peripheral surface 31a (frontward) about the base 41 side. Furthermore, the claw 43 is elastically deformed about the root side in an upward direction, i.e., so as to be folded to the extending portion 42 side.

When, for example, an upward force is applied to the accommodation member 30 in an attempt to pick up a cup inserted into the accommodation member 30 in a state obtained after the mounting shown in FIG. 2, the back side of the accommodation member 30 attempts to rotate upward about the first to-be-engaged portion 24. When the upward force is strong, the second engaging portion 40 hooked on the second to-be-engaged portion 25 is elastically deformed. Specifically, the extending portion 42 is elastically deformed toward the outer peripheral surface 31a mainly about the base 41 side in the same manner as in the case of the mounting, and the claw 43 is elastically deformed about the root side in a downward direction which is opposite to the direction in the case of the mounting. When the amount of this elastic deformation increases such that the claw 43 is unhooked from the second to-be-engaged portion 25, the accommodation member 30 is detached from the frame 21.

Therefore, in a case where the rigidity of the extending portion 42, which is mainly elastically deformed when the accommodation member 30 is being mounted or when the accommodation member 30 attempts to come off, is low, the force necessary for the mounting can be decreased, whereby the mountability of the accommodation member 30 to the frame 21 can be improved. Meanwhile, the claw 43 might be easily unhooked from the second to-be-engaged portion 25, and the accommodation member 30 might be easily detached from the frame 21. In contrast, in a case where the rigidity of the extending portion 42 is high, the accommodation member 30 can be made less likely to be detached, whereas the mountability of the accommodation member 30 might deteriorate.

As a measure against these drawbacks, in the present embodiment, the claw 43 and the second to-be-engaged portion 25 are opposed to each other in the upward-downward direction over an overlap length A in a state indicated by an alternate long and two short dashes line in FIG. 2. In this state, as in a case where the claw 43 is detached from the second to-be-engaged portion 25, the extending portion 42 has been brought into contact with the outer peripheral surface 31a of the body portion 31 by elastically deforming the extending portion 42 about the base 41 side from a state where the claw 43 is hooked on the second to-be-engaged portion 25. Consequently, the overlap length A can make it less likely for the claw 43 to be detached from the second to-be-engaged portion 25, almost irrespective of the rigidity of the extending portion 42 (even when the extending portion 42 undergoes significant elastic deformation). In addition, the rigidity of the extending portion 42 does not have to be increased in order to make such detachment less likely in this manner, whereby deterioration of the mountability of the second engaging portion 40 to the second to-be-engaged portion 25 due to increase in the rigidity can be suppressed. By the above features, deterioration of the mountability of the accommodation member 30 to the frame 21 can be suppressed, and moreover, the accommodation member 30 can be made less likely to be detached from the frame 21.

The overlap length A (a dimension in the frontward-backward direction) is not smaller than half a diameter C (a dimension in the frontward-backward direction) of the second to-be-engaged portion 25. Consequently, an appropriate overlap length A can be ensured for the size of the second to-be-engaged portion 25, whereby the accommodation member 30 can be made further less likely to be detached from the frame 21.

A length L2 in the upward-downward direction of the extending portion 42 is larger than a length L1 in the upward-downward direction of the base 41. Consequently, the extending portion 42 can be easily elastically deformed so as to be warped over the entire length thereof in the upward-downward direction at the time of mounting, whereby the mountability of the accommodation member 30 to the frame 21 can be improved. Meanwhile, since the base 41 is small, stresses applied upon elastic deformation of the extending portion 42 easily concentrate on a connection portion between the base 41 and the body portion 31, whereby the durability of the connection portion might decrease.

However, in the present embodiment, the base 41 is connected to the outer peripheral surface 31a and the flange 32 of the body portion 31. Consequently, as compared to a case where the base 41 is connected to only one of the outer peripheral surface 31a or the flange 32, stresses applied to the connection portion upon elastic deformation of the extending portion 42 are easily dispersed, whereby the durability of the connection portion can be ensured.

Furthermore, the base 41 is formed so as to have a U-shaped cross section, and the extending portion 42 extended downward from this base 41 is also formed so as to have a U-shaped cross section. Thus, at a position closer to the lower end of the extending portion 42 far from the base 41 fixed to the body portion 31, the extension side surface sheets 42a are more easily opened and the rigidity of the extending portion 42 becomes lower. Consequently, a more significant elastic deformation can be caused at a position closer to the lower end of the extending portion 42, and stresses can be inhibited from concentrating on a boundary portion between the base 41 and the extending portion 42 upon the elastic deformation. As a result, the durability of the second engaging portion 40 can be improved.

The claw 43 has both upper and lower surfaces each tilted such that a part thereof on a further back side is located on a further upper side. Thus, when the claw 43 passes over the second to-be-engaged portion 25 at the time of mounting, the claw 43 is easily elastically deformed so as to be folded to the extending portion 42 side. Consequently, even when the claw 43 is lengthened for the sake of the overlap length A, the claw 43 can be easily hooked on the second to-be-engaged portion 25. Therefore, the length of the claw 43 makes it less likely for the accommodation member 30 to be detached from the frame 21, and the shape and the thickness of the claw 43 enable improvement of the mountability of the accommodation member 30 to the frame 21.

Furthermore, the thickness of the claw 43 decreases from the root toward the tip thereof as seen in the leftward-rightward direction, and thus the claw 43 is more easily elastically deformed in the thickness direction at a part thereof closer to said tip. The lower surface of the claw 43 is a curved surface that is curved in a convex shape as seen in the leftward-rightward direction, whereby the claw 43 is less likely to be bent downward and is easily bent upward.

As a result of these features, the claw 43 is further easily elastically deformed so as to be folded to the extending portion 42 side. Consequently, even when the claw 43 is lengthened, the claw 43 can be further easily hooked on the second to-be-engaged portion 25. Therefore, the length of the claw 43 makes it further less likely for the accommodation member 30 to be detached from the frame 21, and the shape and the thickness of the claw 43 enable further improvement of the mountability of the accommodation member 30 to the frame 21.

As shown in FIG. 4, the root of the claw 43 has a thickness T1 of preferably 5 mm or larger and 10 mm or smaller as seen in the leftward-rightward direction. When the thickness T1 is 5 mm or larger, the claw 43 can be made less likely to be detached from the second to-be-engaged portion 25 even upon application of a force of about 100 N to the accommodation member 30. When the thickness T1 is 10 mm or smaller, the claw 43 can be easily elastically deformed so as to be folded to the extending portion 42 side. Therefore, when the thickness T1 is 5 mm or larger and 10 mm or smaller, the accommodation member 30 can be made still even less likely to be detached from the frame 21, and the mountability of the accommodation member 30 to the frame 21 can be still even more improved.

In addition, the extending portion 42 has, on the base 41 side, a root having a second moment of area of preferably 100 mm⁴ or larger and more preferably 300 mm⁴ or larger in a cross section M perpendicular to a direction in which the extending portion 42 extends (the upward-downward direction in FIG. 2 in which the accommodation member 30 has been mounted to the frame 21). The cross section M is taken at a position, in the root of the extending portion 42, that is on the lower side relative to a curve for smooth connection to the lower end of the base 41.

When the above second moment of area is 100 mm⁴ or larger, the accommodation member 30 can be made further less likely to be detached from the frame 21. When the above second moment of area is 300 mm⁴ or larger, the accommodation member 30 can be made still even less likely to be detached from the frame 21. Furthermore, when the above second moment of area is 100 mm⁴ or larger and the above thickness T1 is 5 mm or larger and 10 mm or smaller, the balance between the rigidities of the claw 43 and the extending portion 42 can be made favorable. Therefore, the accommodation member 30 can be made further less likely to be detached from the frame 21, and moreover, the mountability of the accommodation member 30 to the frame 21 can be still even more improved.

Although the present invention has been described above based on the above embodiment, it can be easily understood that the present invention is not limited to the above embodiment at all, and various modifications and improvements may be made without departing from the gist of the present invention. For example, the shapes, the dimensions, the numbers, and the like of the constituents such as the frame 21, the pad 22, and the accommodation member 30 may be changed as appropriate. The first to-be-engaged portion 24 may be a member having a U shape, and the first engaging portion 33 may be a member having the shape of a round rod.

Although a case where the armrest 20 is rotatably supported on the left side of the seat back 12 has been described in the above embodiment, the present invention is not necessarily limited to this case. For example, the left and right sides of the seat 10 may be inverted such that the armrest 20 is provided on the right side of the seat back 12. Also, without limitation to a case where the armrest 20 in the accommodated state forms a part of the backrest, the armrest 20 does not have to form a part of the backrest. The seat 10 including the armrest 20 is not limited to a back seat of a car and may be a front seat of a car, a seat mounted in a vehicle other than a car, or a seat that is not mounted in a vehicle.

Although a case where the accommodation member 30 is a cup holder has been described in the above embodiment, the present invention is not necessarily limited to this case. For example, an ashtray, a small article container, an operation device for an in-vehicle apparatus, or the like may be used as the accommodation member 30. Also, without limitation to a case where the constituents of the accommodation member 30 are integrally formed, the body portion 31 and each of the first engaging portion 33 and the second engaging portion 40 may be formed of different members, for example. Also, a part or the entirety of the accommodation member 30 may be formed of a metal.

Although a case where the first engaging portion 33 and the second engaging portion 40 are respectively provided on the front side and the back side of the accommodation member 30 has been described in the above embodiment, the present invention is not necessarily limited to this case. The first engaging portion 33 and the second engaging portion 40 may be respectively provided on the back side and the front side of the accommodation member 30. The first engaging portion 33 and the second engaging portion 40 may be respectively provided on one side and another side in the leftward-rightward direction of the accommodation member 30. In another example, the first engaging portion 33 and the second engaging portion 40 may be respectively provided on the front right and the back left of the accommodation member 30. Also, the number of the first engaging portions 33 and the number of the second engaging portions 40 are not limited to two, each of the numbers may be one or may be three or more, and the position(s) thereof relative to the restriction portions 34 is not particularly limited, either. In any of the cases, the first to-be-engaged portion 24 and the second to-be-engaged portion 25 only have to be provided to the position at which the first engaging portion 33 is to be attached and the position at which the second engaging portion 40 is to be hooked, respectively.

Although a case where the base 41 of the second engaging portion 40 is connected to the outer peripheral surface 31a and the flange 32 of the body portion 31 has been described in the above embodiment, the present invention is not necessarily limited to this case. For example, the base 41 may be connected to the outer peripheral surface 31a alone or may be connected to the flange 32 alone.

### DESCRIPTION OF REFERENCE NUMERALS

20 armrest
21 frame
22 pad
22a recess
24 first to-be-engaged portion
25 second to-be-engaged portion
30 accommodation member
31 body portion
31a outer peripheral surface
32 flange
33 first engaging portion
40 second engaging portion
41 base
42 extending portion
43 claw
A overlap length

What is claimed is:

1. An armrest comprising:
a frame;
a pad supported on the frame and formed of foam; and
an accommodation member configured to be accommodated in a recess obtained through recession from an outer surface of the pad to one side in a first direction, wherein the frame includes
a first to-be-engaged portion located on one side, in a second direction perpendicular to the first direction, relative to the accommodation member, and
a second to-be-engaged portion located on another side, in the second direction, relative to the accommodation member,
the accommodation member includes
a body portion having an outer peripheral surface configured to be opposed to an inner peripheral wall surface defining the recess,
a first engaging portion provided to the outer peripheral surface and configured to be attached to the first to-be-engaged portion such that the accommodation member is rotatable in the first direction about the first to-be-engaged portion, and
a second engaging portion elastically deformable and configured to be hooked on the second to-be-engaged portion,
the second engaging portion includes
a base connected to the body portion,
an extending portion extending from the base to the one side in the first direction and disposed away from the outer peripheral surface in the second direction, and
a claw protruding from the extending portion to a side opposite to the outer peripheral surface and having, on another side in the first direction, a surface on which the second to-be-engaged portion is to be hooked, and
the claw and the second to-be-engaged portion are opposed to each other in the first direction over an overlap length in a state where the extending portion has been brought into contact with the outer peripheral surface by elastically deforming the extending portion about the base side from a state where the claw is hooked on the second to-be-engaged portion.

2. The armrest according to claim 1, wherein
the claw has, on the extending portion side, a root having a thickness of 5 mm or larger and 10 mm or smaller as seen in a third direction perpendicular to the first direction and the second direction, and
the extending portion has, on the base side, a root having a second moment of area of 100 mm⁴ or larger in a cross section perpendicular to the first direction.

3. The armrest according to claim 1, wherein
the second to-be-engaged portion is formed in a shape of a round rod extending in a third direction perpendicular to the first direction and the second direction, and
the overlap length is not smaller than half a diameter of the second to-be-engaged portion.

4. The armrest according to claim 1, wherein
the body portion includes a flange protruding outward from an upper end of the outer peripheral surface,
the base is connected to the outer peripheral surface and the flange, and
a length in the first direction of the extending portion is larger than a length in the first direction of the base.
